(19) United States
(12) Patent Application Publication
(10) Pub. No.: US 2012/0276933 A1
(43) Pub. Date: Nov. 1, 2012

(54) DETECTING CHANGE IN SYSTEM INFORMATION

(75) Inventor: Pasi Petteri Laitinen, Oulunsalo (FI)

(73) Assignee: Renesas Mobile Corporation

(21) Appl. No.: 13/096,199

(22) Filed: Apr. 28, 2011

(51) Int. Cl. H04W 68/00

(52) U.S. Cl. 455/458

(57) ABSTRACT

A method, apparatus, and computer program for detecting changes in system information of a radio access network are provided. A terminal device of a cellular communication system is arranged to employ a default procedure in which a change in system information transmitted by a cellular radio access network is detected from a change indicator comprised in at least one paging message received from the cellular radio access network on a paging channel. However, in connection with the terminal device entering a cell, the terminal device is arranged to receive system information associated with the entered cell and to verify validity of the received system information by checking a system information tag broadcasted in the cell on a broadcast channel, the system information tag indicating whether or not there has been a change in the system information.

### FIELD

The invention relates to the field of radio communications and, particularly, to detecting a change in system information in a cellular communication system.

### BACKGROUND

In a modern cellular communication system, e.g. a Long-Term Evolution of Universal Mobile Telecommunication System (UMTS LTE) specified within a 3^{rd} Generation Partnership Project, system information is transmitted by a radio access network. The system information may comprise information instructions for a terminal device (UE) to operate in a cell and/or in the radio access network. The radio access network may, however, change its operational parameters dynamically, which results in the change of the transmitted system information. The change in the system information and failures in detection of the changed system information in the UE may cause undesired effects in the radio access network.

### BRIEF DESCRIPTION

According to an aspect of the present invention, there is provided a method comprising: causing a terminal device of a cellular communication system to employ a default procedure in which a change in system information transmitted by a cellular radio access network is detected from a change indicator comprised in at least one paging message received from the cellular radio access network on a paging channel; and in connection with the terminal device entering a cell, causing the terminal device to receive system information associated with the entered cell and to verify validity of the received system information by checking a system information tag broadcasted in the cell on a broadcast channel, the system information tag indicating whether or not there has been a change in the system information.

According to another aspect of the present invention, there is provided an apparatus comprising at least one processor; and at least one memory including a computer program code. The at least one memory and the computer program code are configured, with the at least one processor, to cause the apparatus to: cause a terminal device of a cellular communication system to employ a default procedure in which a change in system information transmitted by a cellular radio access network is detected from a change indicator comprised in at least one paging message received from the cellular radio access network on a paging channel; and in connection with the terminal device entering a cell, cause the terminal device to receive system information associated with the entered cell and to verify validity of the received system information by checking a system information tag broadcasted in the cell on a broadcast channel, the system information tag indicating whether or not there has been a change in the system information.

According to yet another aspect of the present invention, there is provided a computer program product embodied on a distribution medium readable by a computer and comprising program instructions which, when loaded into an apparatus, execute a computer process comprising: causing a terminal device of a cellular communication system to employ a default procedure in which a change in system information transmitted by a cellular radio access network is detected from a change indicator comprised in at least one paging message received from the cellular radio access network on a paging channel; and in connection with the terminal device entering a cell, causing the terminal device to receive system information associated with the entered cell and to verify validity of the received system information by checking a system information tag broadcasted in the cell on a broadcast channel, the system information tag indicating whether or not there has been a change in the system information.

According to another aspect, there is provided a computer-readable distribution medium carrying the above-mentioned computer program product.

According to another aspect of the present invention, there is provided an apparatus comprising: means for causing a terminal device of a cellular communication system to employ a default procedure in which a change in system information transmitted by a cellular radio access network is detected from a change indicator comprised in at least one paging message received from the cellular radio access network on a paging channel; and means for causing the terminal device, in connection with the terminal device entering a cell, to receive system information associated with the entered cell and to verify validity of the received system information by checking a system information tag broadcasted in the cell on a broadcast channel, the system information tag indicating whether or not there has been a change in the system information.

In an embodiment, the verification from the system information tag is made once after entering the cell, the apparatus further comprising means for resuming the detection of the change in the system information from the paging messages after the one-time verification from the broadcasted system information tag.

In an embodiment, the apparatus further comprises means for monitoring for a determined event triggering the verification after entering the cell; and means for causing the terminal device, upon detection of said event, to verify the validity of the received system information from the system information tag. In an embodiment, the event is a first paging occasion detected in the terminal device after reception of the system information of the entered cell. The first paging occasion may be a reception of the first paging message in the terminal device, and the apparatus may further comprise means for analysing the received first paging message for said change indicator; means for causing the terminal device, if the first paging message indicates the change in the system information, to apply the currently received system information for the duration of a present system information modification period, and to acquire new system information during a subsequent system information modification period; and means for causing the terminal device to check the system information tag, if the first paging message indicates no change in the system information.

In another embodiment, the apparatus comprises means for utilizing a system information modification period boundary of the entered cell as said event triggering the verification, wherein the system information is subject to change at the system information modification period boundary.

Further embodiments of the invention are defined in the dependent claims.

### LIST OF DRAWINGS

Embodiments of the present invention are described below, by way of example only, with reference to the accompanying drawings, in which

FIG. 1 illustrates a generic concept of a cellular communication system to which embodiments of the invention may be applied;

FIG. 2 illustrates communication of system information and notification of changes to the system information;

FIG. 3 illustrates a process for detecting a change in the system information according to an embodiment of the invention;

FIGS. 4 to 6 illustrate further embodiments for verifying validity of received system information; and

FIG. 7 illustrates a block diagram of an apparatus provided with functionality for detecting changes in the system information according to embodiments of the invention.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

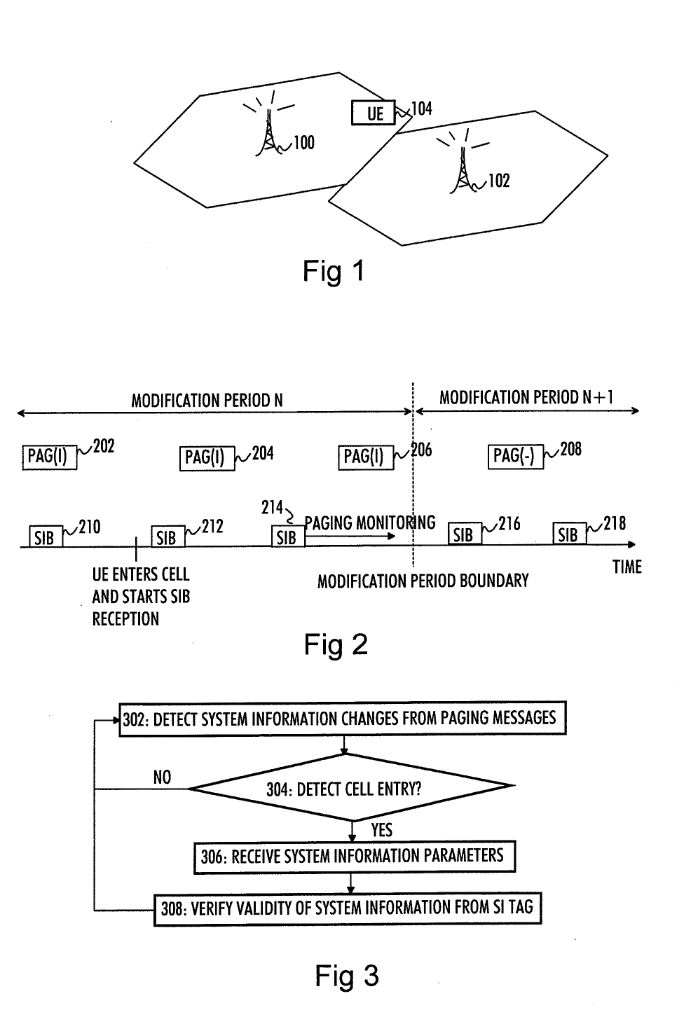

A general concept of a cellular communication system providing voice and data transfer services to terminal devices is illustrated in FIG. 1. The cellular communication system covers a geographical area by a plurality of base stations 100, 102 comprised in a radio access network of the cellular communication system. The base stations 100, 102 are interconnected through appropriate interfaces so as to enable seamless coverage and handover of a terminal device 104 from a service area of one base station 100 to a service area of another base station 102. The cellular communication system may be any modern cellular communication system, e.g. a Universal Mobile Telecommunication System (UMTS) or any one of its evolution versions (e.g. long-term evolution, LTE, or LTE-Advanced), a system based on International Mobile Telecommunication (IMT) standard or any one of its evolution versions (e.g. IMT-Advanced), Worldwide Interoperability for Microwave Access (WiMAX). However, the cellular system is not limited to these examples and it may be any other wireless network within the scope of the present claims.

With respect to mobility of the terminal device 104, the base stations 100, 102 broadcast system information comprising parameters that define rules for operating in each cell. The system information may be broadcasted on a broadcast control channel (BCCH) in System Information Blocks (SIBs) which is a term used in the UMTS LTE. There exists a plurality of different types of SIBs. For example, SIB Type 1 may define access restrictions in the cell and SIB scheduling information, SIB Type 2 may define common and shared channel information defining parameters for random access procedure and for paging configurations, for example, and SIB Type 3 to SIB Type 8 may define cell reselection information for different systems (UMTS, GSM, CDMA2000). Upon entering a cell, the terminal device 104 should first receive the system information from a base station 102 associated with the entered cell and, then, configure its operation according to the rules set by the system information in order to enable its operation in the cell and prevent the terminal device from disrupting the operation of other terminal devices in the cell. The system information may be transmitted by a given base station 100, 102 a number of times with the same content within a modification period. The different base stations 100, 102 may transmit different system information. The modification period is a period in which the system information remains unmodified, and the system information may be changed between subsequent modification periods. The length of the modification period in terms of a length between modification period boundaries is defined by consecutive system frame number (SFN) values for which SFN mod m=0, where m is the number of radio frames in the modification period, e.g. one modification period may be defined as a period from a frame having SFN m to a frame having SFN 2m−1. The modification period may be configured by the system information.

The system information is subject to changes from time to time. For example, the cell access restrictions (SIB1), cell reselection parameters (SIB7), SIB scheduling, and/or SIB timers may change dynamically. In EUTRAN system, change of system information only occurs at specific radio frames, i.e. the concept of a modification period is used. When the radio access network changes (at least some of the) system information, wherein the change is allocated to be executed at the beginning of a next modification period, the radio access network (a base station 100, 102) notifies the terminal devices about this change by transmitting a paging message on a paging channel during a previous modification period. The paging message carries then a change indicator, e.g. a systemInfoModification indication which is a term used in the UMTS LTE, during the previous modification period. When the terminal device 104 receives the paging message including the systemInfoModification indication, the terminal device knows that the system information will change at the next modification period boundary. As a consequence, the terminal device 104 is configured to acquire the new system information after the next modification period boundary. The radio access network applies a plurality of paging occasions, while each terminal device may be configured to scan only some of them. Thus, the base station 100, 102 may be configured to transmit the paging message comprising the change indicator in all possible paging occasions during the modification period preceding the change in order to maximize the probability that all terminal devices in the cell receive the change indication.

The above-mentioned method for detecting a change in the system information is based on that the terminal device 104 scans for the paging messages as a part of conventional idle state or connected state procedures. The radio access network may also provide another option for enabling the terminal device 104 to detect the change in the system information. A SIB Type 1 message contains a system information tag (UMTS LTE uses term systemInfoValueTag). The system information tag indicates that a change of system information has occurred, i.e. network changes the value of the information element at the modification period boundary where content of system information changes. Thus, the terminal device may detect the changes in the system information by actively receiving and processing the SIB Type 1 messages and determining the value of the system information tag.

Typically, a terminal device may employ one of the two above-mentioned methods for detecting the change in the system information. FIG. 2 illustrates a scenario for a terminal device (UE) configured to detect the change in the system information from the paging messages. FIG. 2 illustrates a timeline comprising two modification periods (N and N+1) separated by a modification period boundary shown by a dashed line. A base station of the radio access network has determined to change the system information at the modification period boundary and, therefore, it is configured to notify the upcoming change in the system information in paging messages 202, 204, 206 transmitted during the previous modification period N. The paging messages contain the change indicator, and at least some of the paging messages may be dedicated to transmitting the notification about the upcoming change in the system information. After the modification period boundary, paging messages 208 may not contain the change indicator anymore, and the reason for transmitting the paging message may be other, e.g. it may be a paging occasion related to connection establishment. The base station also transmits (broadcasts) the system information blocks (SIB) 210 to 218 on the BCCH. After the modification period boundary, at least some of the contents of the SIBs is changed. Let us now consider a situation where a terminal device enters a cell of the base station through cell selection, cell reselection, handover, an instruction to change cell received from the radio access network, or in general any procedure that triggers entering a cell at a time instant indicated in FIG. 2. The terminal device may be configured to monitor for the changes in the system information from the paging messages. In connection with entering the cell, the terminal device starts reception of the SIBs so as to determine the operational parameters used in the cell. Let us assume that SIB 214 contains information defining rules for monitoring the paging messages (SIB Type 2). Upon reception of the SIB type 2 message in SIB 214, the terminal device is able to start monitoring for the paging messages. However, the terminal device may start the reception of the paging messages too late to receive any paging messages comprising the change indicator, e.g. the paging message 206. It may be that the last paging message carrying the change indicator may have been transmitted before the terminal device started the monitoring for the paging messages. In another scenario illustrated in FIG. 2, the last paging message 206 carrying the change indicator is transmitted after the terminal device started the monitoring for the paging messages, but the terminal device may still fail to receive the paging message due that the terminal device is not configured to monitor for the paging occasion of the paging message 206, for example. The first paging message 208 received by the terminal device may relate to the subsequent modification period N+1 when the paging messages no longer carry the change indicator. Therefore, the terminal device erroneously assumes that the same system information is applicable in the following modification period N+1, and does not determine the new system information from SIBs 216, 218 of the next modification period N+1. This may result in that the terminal device accesses the cell even if it is no longer allowed to do so. For example, the cell access restrictions may be changed to allow cellular access only for dedicated special access classes (subscribers) for operator maintenance or emergency situation (e.g. earthquake) reasons. In another scenario, the terminal device accesses the cell with incorrect parameters, e.g. it may apply erroneous random access channel procedures, thereby causing problems for all terminal devices in the cell. In yet another scenario, the terminal device is not able to detect neighbour cells of the cell correctly anymore, thereby resulting in out-of-service or other problems because of erroneously operating mobility (cell reselection) procedures.

Some embodiments of the invention provide a solution to the above-mentioned problem (and other problems) by configuring the terminal device to check the SIBs in connection with entering the cell. FIG. 3 illustrates an embodiment of a method for detecting the change in the system information. Referring to FIG. 3, the terminal device is configured to employ a procedure in which a change in system information transmitted by a cellular radio access network is detected from a change indicator comprised in a paging message received from the cellular radio access network on a paging channel (block 302). However, in connection with entering the cell, the terminal device is configured to apply another procedure for detecting the changed system information. In block 304, it is determined whether a cell entry has been detected in the terminal device. The cell entry may be detected as a result of cell (re)selection or handover procedure, or as a result of any other procedure that causes the cell entry. If no cell entry is detected, the normal procedure of block 302 for detecting the changes in the system information is resumed. However, if the cell entry is detected, the process proceeds to block 306, wherein new system information parameters of the entered cell are received. Then, the terminal device is in block 308 configured to verify whether the received system information is valid by checking a system information tag broadcasted in the cell on a broadcast channel, the tag indicating whether or not there has been a change in the system information.

With reference to FIG. 2, the above-described embodiment configures the terminal device to verify whether the currently received system information is applicable also during the following modification period from the SIB, e.g. SIB Type 1 message carrying the systemInfoValueTag. This ensures that the terminal device does not miss the change in the system information even though it cannot receive any paging message before the modification period boundary upon entering the cell. The detection of the change in the system information from the paging messages may provide an advantage that the terminal device does not need to actively read and analyse the broadcasted system information messages in order to carry out the detection. Thus, power consumption is reduced. However, in some cases the active detection of the change may be advantageous so as to prevent erroneous operation of the terminal device, e.g. in connection with entering the cell. Therefore, the terminal device may be configured in such special occasions to actively carry out the analysis of the broadcasted system information messages. This both reduces the power consumption and ensures correct operation of the terminal device in the entered cell.

The verification of the change in the system information by analysing the system information tag may be made only once after entering the cell. Thereafter, the terminal device may resume the default operation of detecting the change in the system information from the paging messages. With reference to FIG. 3, after the one-time verification from the broadcasted system information tag in block 308, the process may return to block 302 to resume the detection of the change in the system information from the paging messages.

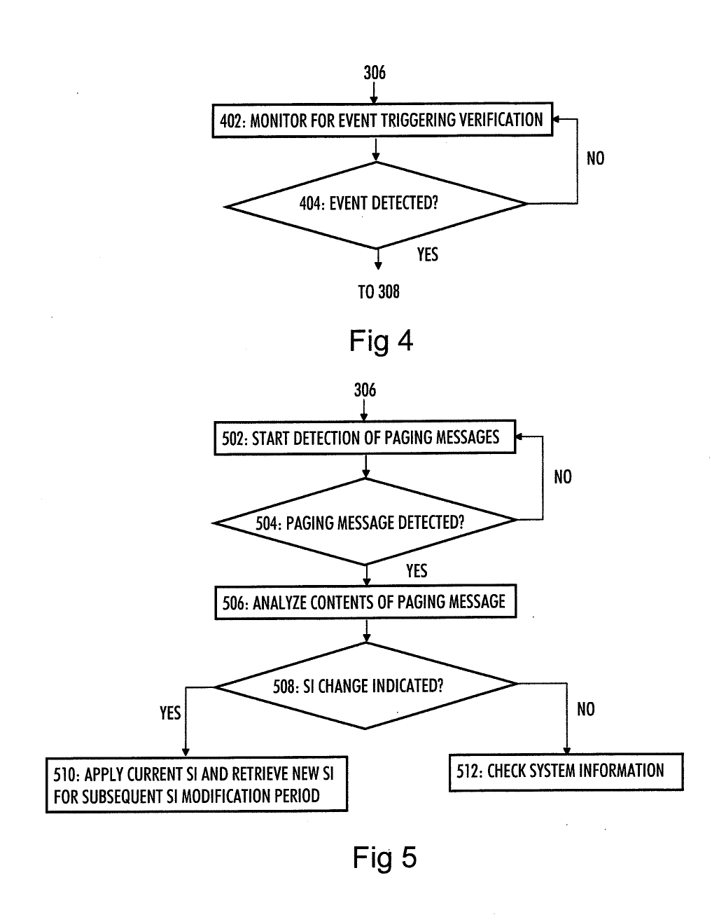

In an embodiment, the SIB from which the verification is made (block 308) is associated with a subsequent modification period (N+1) with respect to the modification period (N) in which the system information of the entered cell was received (block 306). In order to ensure that the verification is carried out during the subsequent modification period, an embodiment provides a mechanism which configures the terminal device to monitor for a determined event before executing the verification. FIG. 4 illustrates an embodiment of such a modification to the flow diagram of FIG. 3. Referring to FIG. 4, the process proceeds from block 306 to block 402 in which the terminal device is configured to monitor for an event triggering the verification procedure. Before monitoring, the system information may have been retrieved and stored in a memory unit of the terminal device. In block 404, it is determined whether or not such an event is detected. If the event is detected, the process proceeds to block 308. Otherwise, the monitoring is continued in block 402.

In an embodiment, the event being monitored for is a paging occasion, e.g. reception of a first paging message from the serving base station after entering the cell of the serving base station. FIG. 5 illustrates a flow diagram according to some embodiments using the paging occasion as the trigger for executing block 308. Referring to FIG. 5, the process proceeds from block 306 to block 502 in which the terminal device is configured to start monitoring for paging messages in the newly entered cell. In block 504, it is determined whether or not a paging message is received from the base station of the entered cell. If no paging message is received, the monitoring is resumed in block 502. On the other hand, if the terminal device detects reception of a paging message, the process proceeds to block 506 in which the terminal device is configured to analyse the contents of the paging message. In an embodiment, the analysis in block 506 comprises checking whether or not the paging message indicates the change in the system information, e.g. by checking whether or not the paging message comprises the above-mentioned change indicator. In block 508, it is determined whether the received paging message indicates the upcoming change in the system information. If the change is indicated in the paging message, e.g. by the presence of the change indicator, it means that the currently received system information is still valid for the present modification period and that the system information will be changed for the subsequent modification period. Therefore, the process proceeds to block 510 in which the terminal device is configured to continue to apply the currently received system information for the duration of the current modification period and to retrieve new system information for the subsequent modification period. On the other hand, if the paging message contains no indication of the change of the system information, e.g. the change indicator is absent, it means that the currently retrieved system information may already be invalid. Therefore, the terminal device is configured to check the system information tag comprised in the system information broadcasted by the serving base station in order to determine whether or not the system information has changed between the initiation of block 502 and the reception of the first paging message in blocks 504 to 508. This hybrid procedure ensures that either the upcoming change is detected from the paging message(s) during the modification period N in which the terminal device entered the cell, or the change is detected from the system information tag during the modification period N+1 when the system information is changed. In either case, the procedure ensures that the system information applied by the terminal device is up-to-date.

In another embodiment, the paging occasion triggering the verification procedure is the detection of a time instant in which the terminal device is configured to monitor a paging channel (PCH) for a paging message addressed to the terminal device. In other words, the paging occasion may be defined as the first time instant where there is a possibility for the terminal device to receive a paging message (after the cell entry). The first paging occasion may or may not contain a paging message for the terminal device.

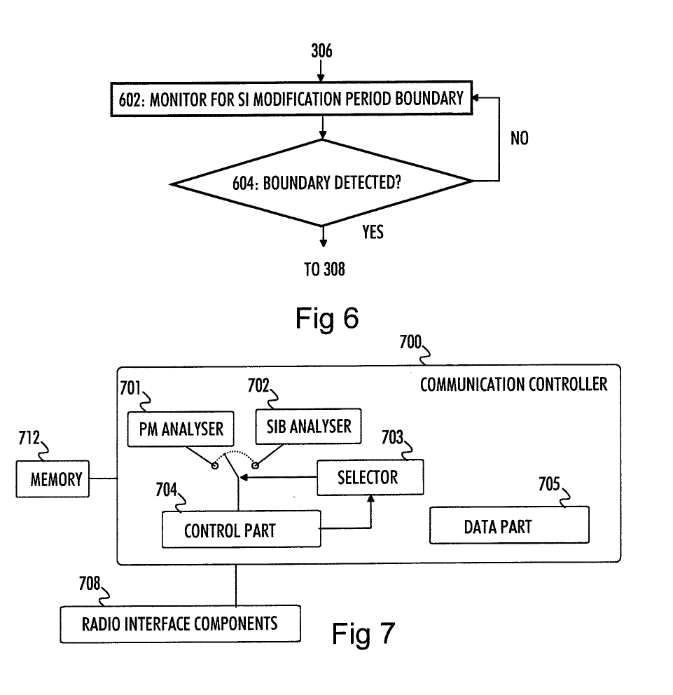

In another embodiment, the event being monitored for in the embodiment of FIG. 4 is the modification period boundary. The modification period boundary may be detected by monitoring the system frame number. As mentioned above, the modification period is inherently periodic and comprises a determined number of system frames, so the modification period boundary may be determined by tracking the system frame number. FIG. 6 illustrates a flow diagram of the process according to this embodiment. Referring to FIG. 6, the process proceeds from block 306 to block 602 where the modification period boundary is monitored for in the terminal device. In block 604, it is determined whether or not the modification period boundary is detected. Upon detection of the modification period boundary in block 604, the execution of block 308 is triggered. Otherwise, the process resumes block 602 for detecting the modification period boundary.

The embodiments of FIGS. 5 and 6 may be combined to achieve an embodiment where the terminal device is configured to monitor for both the paging occasion and the modification period boundary as the event triggering the verification of the validity of the received system information (block 402). If the first event detected is the paging occasion, the terminal device may follow the procedure of FIG. 5 by executing at least some of the blocks 506 to 512. On the other hand, if the first event detected is the modification period boundary, the terminal device may follow the procedure of FIG. 6.

An embodiment provides an apparatus comprising at least one processor and at least one memory including a computer program code, wherein the at least one memory and the computer program code are configured, with the at least one processor, to cause the apparatus to carry out any one of the above-described processes for detecting the change in the system information. The apparatus may comprise the terminal device of a cellular communication system, e.g. a computer (PC), a laptop, a tabloid computer, a cellular phone, a communicator, a smart phone, a palm computer, or any other communication apparatus. In another embodiment, the apparatus is comprised in such a terminal device, e.g. the apparatus may comprise a circuitry, e.g. a chip, a processor, a micro controller, or a combination of such circuitries in the terminal device and cause the terminal device to carry out the above-described functionalities.

FIG. 7 illustrates an embodiment of such an apparatus. The apparatus may comprise a communication controller circuitry 700 configured to control the communications in the apparatus. The communication controller circuitry 700 may comprise a control part 704 handling control plane signalling with a radio access network of the cellular communication system. For example, the control part may control establishment, operation, and termination of cellular connections with one or more base stations of the radio access network and carry out radio resource control procedures under the control of the radio access network. The control part 704 may also be configured to retrieve the above-mentioned system information from the SIBs broadcasted by the radio access network. The communication controller circuitry 700 may further comprise a data part 705 that handles transmission and reception of payload data with the radio access network. The data part 705 may control transmission of data received from an application executed in the terminal device towards the radio access network. Similarly, the data part 705 may control reception of data from the radio access network and process the received data into a format applicable to the application utilizing the cellular connection.

Additionally, the apparatus may comprise one or more circuitries configured to detect the change in the system information. The apparatus may comprise a paging message analyser circuitry 701 configured to detect the change in the system information from the paging messages received from the radio access network, as described above. The apparatus may further comprise a system information block analyser circuitry 702 configured to detect the change in the system information from the system information messages received from the radio access network, as described above. Accordingly, the terminal device may be provided with capability to determine the validity of the system information according to a plurality of procedures. The apparatus may further comprise a selector circuitry 703 configured to select which one of the analyser circuitries 701, 702 is activated. The selector circuitry 703 thus selects one of the analyser circuitries 701, 702 to execute the verification of the validity of the system information at a time. The selector circuitry may be configured to select the paging message analyser circuitry to carry out the verification by default. However, upon reception from the control part 704 a signal indicating that the terminal device has just entered a cell as a result of the cell (re)selection or handover (or upon detection of the cell entry by other procedure), the selector circuitry 703 may be configured to activate the system information analyser circuitry to carry out the verification of the validity of the system information. The selector circuitry 703 may even disable the paging message analyser circuitry until the validity of the system information has been verified by the system information analyser circuitry. After the verification, the selector circuitry 703 may again activate the paging message analyser circuitry 701 and resume the default procedure for detecting the changes in the system information.

The circuitries 701 to 705 of the communication controller circuitry 700 may be carried out by the one or more physical circuitries or processors. In practice, the different circuitries may be realized by different computer program modules. Depending on the specifications and the design of the apparatus, the apparatus may comprise some of the circuitries 702 to 705 or all of them.

The apparatus may further comprise one or more memories 712 that store computer programs (software) configuring the apparatus to perform the above-described functionalities of the terminal device. The memory 712 may also store communication parameters and other information needed for the wireless communications and/or to carry out the detection of the change in the system information. For example, the memory 712 may store the system information as retrieved by the control part 704. Upon reception of new system information, the old system information may be discarded so as to maintain the system information up-to-date. The apparatus may further comprise radio interface components 708 providing the apparatus with radio communication capabilities with the radio access network. The radio interface components 708 may comprise standard well-known components such as amplifier, filter, frequency-converter, (de)modulator, and encoder/decoder circuitries and one or more antennas.

In an embodiment, the apparatus carrying out the embodiments of the invention for detecting the change in the system information comprises at least one processor and at least one memory including a computer program code, wherein the at least one memory and the computer program code are configured, with the at least one processor, to cause the apparatus to carry out any one of the processes of FIGS. 3 to 6. Accordingly, the at least one processor, the memory, and the computer program code form an embodiment of processing means for carrying out embodiments of the present invention in the terminal device.

As used in this application, the term ‘circuitry’ refers to all of the following: (a) hardware-only circuit implementations, such as implementations in only analogue and/or digital circuitry, and (b) to combinations of circuits and software (and/or firmware), such as (as applicable): (i) a combination of processor(s) or (ii) portions of processor(s)/software including digital signal processor(s), software, and memory(memories) that work together to cause an apparatus to perform various functions, and (c) to circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term “circuitry” also covers an implementation of merely a processor (or multiple processors) or portion of a processor and its (or their) accompanying software and/or firmware. The term “circuitry” also covers, for example and if applicable to the particular element, a baseband integrated circuit or application-specific integrated circuit for a mobile phone.

The processes or methods described in FIGS. 3 to 6 may also be carried out in the form of a computer process defined by a computer program. The computer program may be in source code form, object code form, or in some intermediate form, and it may be stored in some sort of carrier, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital processing unit or it may be distributed amongst a number of processing units.

The present invention is applicable to cellular or mobile telecommunication systems defined above but also to other suitable telecommunication systems. The protocols used, the specifications of mobile telecommunication systems, their network elements and subscriber terminals, develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

1. A method, comprising:
causing a terminal device of a cellular communication system to employ a default procedure in which a change in system information transmitted by a cellular radio access network is detected from a change indicator comprised in at least one paging message received from the cellular radio access network on a paging channel;
in connection with the terminal device entering a cell, causing the terminal device to receive system information associated with the entered cell and to verify validity of the received system information by checking a system information tag broadcasted in the cell on a broadcast channel, the system information tag indicating whether or not there has been a change in the system information.

2. The method of claim 1, wherein the verification from the system information tag is made once after entering the cell, the method further comprising:
after the one-time verification from the broadcasted system information tag, resuming the detection of the change in the system information from the paging messages.

3. The method of claim 1, further comprising:
after entering the cell, monitoring for a determined event triggering the verification; and
upon detection of said event, causing the terminal device to verify the validity of the received system information from the system information tag.

4. The method of claim 3, wherein the event is a first paging occasion detected in the terminal device after reception of the system information of the entered cell.

5. The method of claim 4, wherein the first paging occasion is reception of the first paging message in the terminal device, the method further comprising:
analysing the received first paging message for said change indicator;
if the first paging message indicates the change in the system information, causing the terminal device to apply the currently received system information for the duration of a present system information modification period, and to acquire new system information during a subsequent system information modification period; and
if the first paging message indicates no change in the system information, causing the terminal device to check the system information tag.

6. The method of claim 4, wherein the change in the system information is determined on the basis of presence or absence of the change indicator in the received first paging message.

7. The method of claim 3, wherein the event is detection of a system information modification period boundary of the entered cell, wherein the system information is subject to change at the system information modification period boundary.

8. The method of claim 1, wherein the system information tag is a system info value tag comprised in a system information block type 1 message broadcasted by the cellular radio access network.

9. The method of claim 1, wherein the system information defines operational parameters for radio access in the cell.

10. An apparatus comprising:
at least one processor; and
at least one memory including a computer program code, wherein the at least one memory and the computer program code are configured, with the at least one processor, to cause the apparatus to:
cause a terminal device of a cellular communication system to employ a default procedure in which a change in system information transmitted by a cellular radio access network is detected from a change indicator comprised in at least one paging message received from the cellular radio access network on a paging channel; and
in connection with the terminal device entering a cell, cause the terminal device to receive system information associated with the entered cell and to verify validity of the received system information by checking a system information tag broadcasted in the cell on a broadcast channel, the system information tag indicating whether or not there has been a change in the system information.

11. The apparatus of claim 10, wherein the verification from the system information tag is made once after entering the cell, and wherein the at least one memory and the computer program code are configured, with the at least one processor, to cause the apparatus, after the one-time verification from the broadcasted system information tag, to resume the detection of the change in the system information from the paging messages.

12. The apparatus of claim 10, wherein the at least one memory and the computer program code are configured, with the at least one processor, to cause the apparatus to:
after the terminal device has entered cell, monitor for a determined event triggering the verification; and
upon detection of said event, cause the terminal device to verify the validity of the received system information from the system information tag.

13. The apparatus of claim 12, wherein the event is a first paging occasion detected after reception of the system information of the entered cell.

14. The apparatus of claim 13, wherein the first paging occasion is reception of the first paging message in the terminal device, and wherein the at least one memory and the computer program code are configured, with the at least one processor, to cause the apparatus to:
analyse the received first paging message for said change indicator;
if the first paging message indicates the change in the system information, cause the terminal device to apply the currently received system information for the duration of a present system information modification period, and to acquire new system information during a subsequent system information modification period; and
if the first paging message indicates no change in the system information, cause the terminal device to check the system information tag.

15. The apparatus of claim 13, wherein the at least one memory and the computer program code are configured, with the at least one processor, to cause the apparatus to determine the change in the system information on the basis of presence or absence of the change indicator in the received first paging message.

16. The apparatus of claim 12, wherein the event is detection of a system information modification period boundary of the entered cell, wherein the system information is subject to change at the system information modification period boundary.

17. The apparatus of claim 10, wherein the system information tag is a system info value tag comprised in a system information block type 1 message broadcasted by the cellular radio access network.

18. The apparatus of claim 10, wherein the system information defines operational parameters for radio access in the cell.

19. The apparatus of claim 11, further comprising radio interface components providing the apparatus with radio communication capability.

20. An apparatus, comprising:
means for causing a terminal device of a cellular communication system to employ a default procedure in which a change in system information transmitted by a cellular radio access network is detected from a change indicator comprised in at least one paging message received from the cellular radio access network on a paging channel;
means for causing the terminal device, in connection with the terminal device entering a cell, to receive system information associated with the entered cell and to verify validity of the received system information by checking a system information tag broadcasted in the cell on a broadcast channel, the system information tag indicating whether or not there has been a change in the system information.

21. A computer program product embodied on a distribution medium readable by a computer and comprising program instructions which, when loaded into an apparatus, execute a computer process comprising:
causing a terminal device of a cellular communication system to employ a default procedure in which a change in system information transmitted by a cellular radio access network is detected from a change indicator comprised in at least one paging message received from the cellular radio access network on a paging channel;
in connection with the terminal device entering a cell, causing the terminal device to receive system information associated with the entered cell and to verify validity of the received system information by checking a system information tag broadcasted in the cell on a broadcast channel, the system information tag indicating whether or not there has been a change in the system information.
